(19) United States
(12) Patent Application Publication
(10) Pub. No.: US 2017/0277641 A1
(43) Pub. Date: Sep. 28, 2017

(54) INTEGRATED CIRCUIT, INFORMATION PROCESSING APPARATUS, AND INFORMATION PROCESSING METHOD

(71) Applicant: FUJI XEROX CO., LTD., Tokyo (JP)

(72) Inventors: Shunji TSUNASHIMA, Kanagawa (JP); Kenichi TAKAHASHI, Kanagawa (JP); Kazuo HAYASHI, Kanagawa (JP)

(73) Assignee: FUJI XEROX CO., LTD., Tokyo (JP)

(21) Appl. No.: 15/246,924

(22) Filed: Aug. 25, 2016

(30) Foreign Application Priority Data
Mar. 22, 2016 (JP) 2016-057620

(51) Int. Cl. G06F 12/14; G06F 3/06

(52) U.S. Cl. CPC G06F 12/1416; G06F 3/0622; G06F 3/0623; G06F 3/0637; G06F 3/0673; G06F 12/1408; G06F 2212/1052; G06F 2212/402

(57) ABSTRACT

An integrated circuit includes a processing circuit, a first memory, and a writing unit. The processing circuit includes a memory space and stores data in the memory space and performs processing. The first memory stores permission information indicating a range permitted to be used in the memory space. The writing unit writes, in response to a request to write data to a specified address in the memory space, the data to the specified address in a case where the permission information indicating a range including the specified address is stored.

### CROSS-REFERENCE TO RELATED APPLICATIONS

This application is based on and claims priority under 35 USC 119 from Japanese Patent Application No. 2016-057620 filed Mar. 22, 2016.

### BACKGROUND

### Technical Field

The present invention relates to an integrated circuit, an information processing apparatus, and an information processing method.

### SUMMARY

According to an aspect of the invention, there is provided an integrated circuit including a processing circuit, a first memory, and a writing unit. The processing circuit includes a memory space and stores data in the memory space and performs processing. The first memory stores permission information indicating a range permitted to be used in the memory space. The writing unit writes, in response to a request to write data to a specified address in the memory space, the data to the specified address in a case where the permission information indicating a range including the specified address is stored.

### BRIEF DESCRIPTION OF THE DRAWINGS

An exemplary embodiment of the present invention will be described in detail based on the following figures, wherein:

FIG. 1 illustrates a hardware configuration of an image processing apparatus according to an exemplary embodiment;

FIG. 2 illustrates a detailed configuration of a controller and a system-on-a-chip (SOC);

FIG. 3 illustrates an example of a lookup table (LUT) stored on an LUT memory;

FIG. 4 illustrates an example of the LUT stored before an initial setup process;

FIG. 5 illustrates an example of an operation procedure performed by individual components during the initial setup process; and

FIG. 6 illustrates an example of an operation procedure performed by the individual components during a module use process.

### DETAILED DESCRIPTION

### 1. Exemplary Embodiment

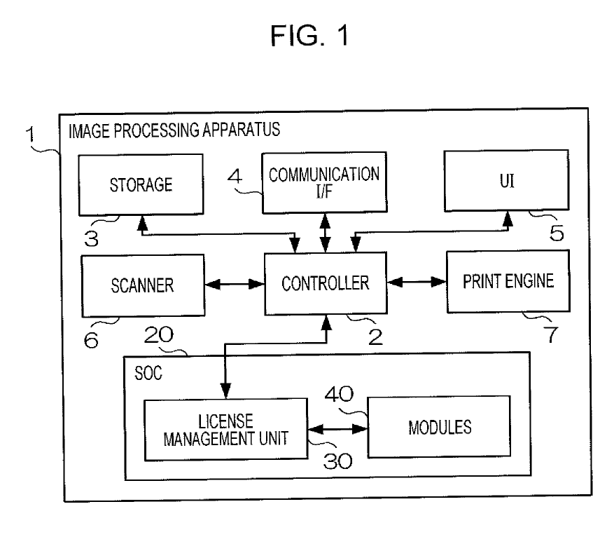

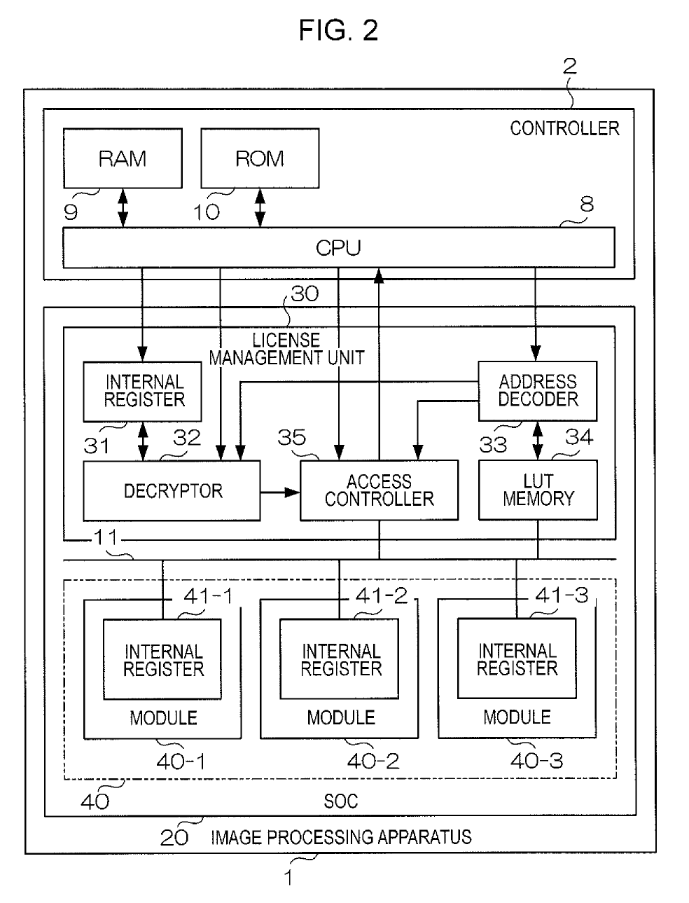

FIG. 1 illustrates a hardware configuration of an image processing apparatus 1 according to an exemplary embodiment. The image processing apparatus 1 is an information processing apparatus that performs processing, such as scanning, printing, copying, and faxing, on image information. The image processing apparatus 1 includes a controller 2, a storage 3, a communication interface (I/F) 4, a user interface (UI) 5, a scanner 6, a print engine 7, and a system-on-a-chip (SOC) 20. The SOC 20 includes a license management unit 30 and modules 40-1, 40-2, and 40-3 (see FIG. 2), which are collectively referred to as “modules 40” below when they are not distinguished from one another.

The controller 2 controls individual components of the image processing apparatus 1. The storage 3 is a storage medium, such as a hard disk drive (HDD) or a solid state drive (SSD). The storage 3 stores a program and data, for example. The communication I/F 4 is connected to a communication line and implements communication between the image processing apparatus 1 and an external apparatus via the communication line. The UI 5 is an interface that implements information exchange between the image processing apparatus 1 and the user. The UI 5 includes a touchscreen, buttons, and the like. The UT 5 displays information indicating the state of the image processing apparatus 1 and the state of processing, for example. The UI 5 also displays images of operation buttons and accepts a user operation or accepts an operation of pressing a hardware button. The scanner 6 includes an image sensor or the like and optically scans an image on the surface of paper. The print engine 7 forms an image on a medium such as paper, for example, by using an electrophotographic system.

The SOC 20 is a semiconductor integrated circuit in which functions relating to image processing are integrally implemented. The modules 40 are circuits (modules) included in the SOC 20, such as circuits that perform image processing and circuits that perform other processing. The modules 40 include a module that implements plural different functions and a module that performs processing on the basis of plural different parameters. For example, a module A that converts the file format of an image implements a function B1 for converting the file format into a generic format and a function B2 for converting the file format into a special format and is able to select a resolution parameter from among plural resolution parameters (parameters C1, C2, etc.) for a single format.

In this exemplary embodiment, there is a license agreement (licensing contract) between a provider of the image processing apparatus 1 and a user of the image processing apparatus 1. The provider gives the use permission to the user on a module-by-module basis. Conversely, there may be module(s) which the user is not authorized to use. That is, the permission for use of each module is given on a function-by-function and parameter-by-parameter basis. For example, in the case of the module A, a certain user is authorized to use the functions B1 and B2 and the parameters C1 and C2, whereas another user is authorized to use the function B1 and the parameter C1 only. The license management unit 30 is a unit that manages licenses for the modules 40. The license management method will be described in detail later.

FIG. 2 illustrates a detailed configuration of the controller 2 and the SOC 20. The controller 2 includes a central processing unit (CPU) 8, a random access memory (RAM) 9, and a read only memory (ROM) 10. The CPU 8 executes a program stored on the ROM 10 or the storage 3 by using the RAM 9 as its workspace, thereby controlling operations of the individual components. The license management unit 30 and the modules 40 of the SOC 20 are connected to each other via an interconnect 11 to exchange data.

The modules 40-1, 40-2, and 40-3 respectively include internal registers 41-1, 41-2, and 41-3, which are collectively referred to as “internal registers 41” below when they are not distinguished from one another. Each of the modules 40 stores data on the corresponding internal register 41, which is a storage space thereof, and performs processing. Examples of the data stored on the internal register 41 by the module 40 include parameters used in processing, data subjected to processing, and an address of a storage space where data subjected to processing is stored (on an external storage). If the data stored on the internal register 41 is parameters, the module 40 performs processing on the basis of content of the stored parameters. Each of the modules 40 is an example of a “processing circuit” according to an aspect of the present invention. Each of the internal registers 41 is partitioned into two or more storage spaces in this exemplary embodiment. Each of the resultant storage spaces (hereafter, referred to as “divisional spaces”) stores data used in processing and data of processing result, for example,

When the CPU 8 uses the module 40, that is, requests the module 40 to perform processing, the CPU 8 requests the module 40 to write data used in the processing by specifying an address of a divisional space used in the processing. The CPU 8 is an example of a “requesting unit” according to an aspect of the present invention. Specifically, the CPU 8 supplies the license management unit 30 with address data that specifies the address of the divisional space used in the requested processing, command data that represents a command (instruction) for performing the processing, and write data that is to be written to the divisional space to use the data in the processing. The write data is, for example, data to be used in the requested processing. The license management unit 30 determines whether the user is authorized to cause the module 40 to perform the requested processing, that is, whether the user is authorized to use the module 40, on the basis of the supplied pieces of data.

The license management unit 30 includes an internal register 31, a decryptor 32, an address decoder 33, a lookup table (LUT) memory 34, and an access controller 35. The internal register 31 stores one secret key and one or more public keys supplied by the CPU 8. Write data supplied by the CPU 8 is encrypted using the secret key and one of the public keys, which will be described in detail later.

Upon being supplied with the encrypted write data from the CPU 8, the decryptor 32 decrypts the encrypted write data by using the secret key and the public key that are stored on the internal register 31. The decryptor 32 then supplies the resultant write data to the access controller 35. The public key used by the decryptor 32 to decrypt the encrypted write data is determined on the basis of information supplied by the address decoder 33, which will be described in detail later.

The CPU 8 supplies the address data to the address decoder 33. The address decoder 33 determines whether the use of the module 40 to perform processing requested by the CPU 8 is authorized, by using the address data supplied by the CPU 8. The address decoder 33 makes this determination by referring to an LUT stored on the LUT memory 34.

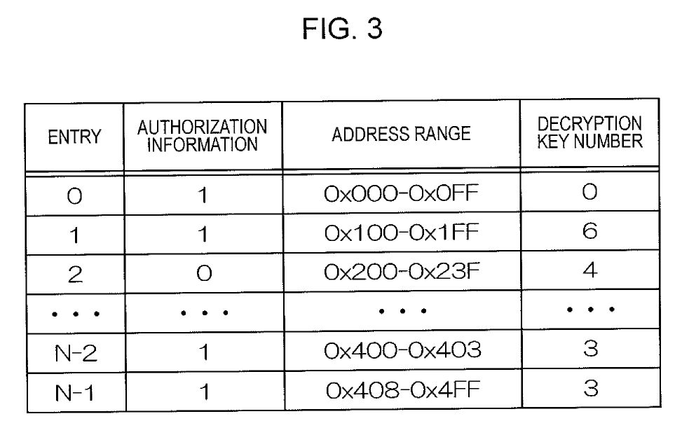

FIG. 3 illustrates an example of the LUT stored on the LUT memory 34. In the LUT illustrated in FIG. 3, items “ENTRY”, “AUTHORIZATION INFORMATION”, “ADDRESS RANGE”, and “DECRYPTION KEY NUMBER” are associated with each other. The item “ENTRY” indicates the serial number assigned to each row of the LUT. The item “AUTHORIZATION INFORMATION” indicates whether use of each divisional space is authorized. Specifically, “1” indicates “authorized”, that is, the use of the divisional space is authorized; whereas “0” indicates “unauthorized”, that is, the use of the divisional space is not authorized. In this way, the LUT indicates a range authorized to be used in the memory space (the internal register 41) of the module 40. The LUT is an example of “permission information” according to an aspect of the present invention, and the LUT memory 34 is an example of a “first memory” that stores the permission information according to an aspect of the present invention.

The item “ADDRESS RANGE” represents a range of a divisional space by using the start address and the end address of the divisional space of the internal register 41, except for the first row. The address range “0x000-0x0FF” at the first row is the address range of the internal register 31 of the license management unit 30 instead of those of the modules 40. The item “DECRYPTION KEY NUMBER” indicates the number assigned to the decryption key used to encode write data to be written to the corresponding divisional space. The decryption key number is a number assigned to each of the one or more public keys stored on the internal register 31.

If an address range including an address specified by the address data supplied by the CPU 8 is listed in the LUT, the address decoder 33 reads the authorization information and the decryption key number associated with the address range. For example, when address data that specifies an address “0x185” is supplied, the address decoder 33 reads the authorization information “1” associated with an address range “0x100-0x1FF” including that address and the decryption key number “6” associated with that address range. The address decoder 33 supplies the read authorization information to the access controller 35 together with the address data supplied thereto by the CPU 8 and supplies the read decryption key number to the decryptor 32.

The decryptor 32 reads the public key assigned the supplied decryption key number and the secret key from the internal register 31 and decrypts the encrypted write data. For example, the storage 3 stores information indicating the same combinations of the address range and the decryption key number as those in the LUT. The CPU 8 refers to this information and encrypts write data by using the public key assigned the decryption key number associated with the address range of the divisional space. Accordingly, the decryptor 32 decrypts the encrypted write data by using the public key used by the CPU 8 for encryption.

The access controller 35 controls an access of the CPU 8 to each of the modules 40. The access controller 35 is supplied with the authorization information and the address data by the address decoder 33, with the command data by the CPU 8, and with the write data by the decryptor 32. If the access controller 35 is supplied with the authorization information “1” (i.e., authorized), the access controller 35 determines that writing of the write data to the internal register 41 of the module 40 is authorized.

If the access controller 35 determines that writing of the write data to the internal register 41 of the module 40 is authorized, the access controller 35 supplies, via the interconnect 11, the write data supplied by the decryptor 32 together with the address data and the command data supplied by the CPU 8 to the module 40 associated with the address specified by the address data supplied by the address decoder 33. Upon being supplied with these pieces of data via the interconnect 11, the module 40 writes the supplied write data to the address specified by the supplied address data and performs processing using the write data written on the internal register 41 (e.g., computation processing using a value represented by the write data, for example) in accordance with the command indicated by the supplied command data.

As described above, in response to a request to write the write data to a specified address in a memory space (the internal register 41) of the module 40, the access controller 35 writes the write data to the specified address if the LUT memory 34 stores the permission information (LUT) representing a range including the specified address. The access controller 35 is an example of a “writing unit” according to an aspect of the present invention. After the module 40 has performed the processing, the module 40 supplies response data indicating that the processing has been performed to the access controller 35 via the interconnect 11. The access controller 35 supplies the response data to the CPU 8.

If the access controller 35 determines that writing of the write data is not authorized on the basis of the authorization information, the access controller 35 supplies response data indicating that writing is not authorized to the CPU 8. The CPU 8 determines whether the processing based on the command issued for the module 40 has been performed on the basis of the response data supplied by the access controller 35 in this manner. As described above, the access controller 35 functions as a notification unit that sends a notification to a source (i.e., the CPU 8) of the request to write the write data to a specified address if the specified address is not included in the address range authorized to be used.

In this case, the access controller 35 discards the supplied write data instead of supplying the write data to the module 40 associated with the specified address. In this way, write data is prevented from being written to the address of the divisional space for which writing of data is not authorized. Note that the method for preventing the write data from being written is not limited to this one. The access controller 35 may prevent the write data from being written to the divisional space by issuing an instruction to stop supplying a clock to a circuit that writes the data to the target divisional space or by issuing an instruction to keep resetting that circuit, for example. The access controller 35 controls an access to each of the modules 40 in units of divisional spaces of the internal register 41 in the above-described manner.

The LUT illustrated in FIG. 3 is an example. An LUT having content based on a license agreement established between the provider and the user of the image processing apparatus 1 is stored on the LUT memory 34 when the user starts using the image processing apparatus 1. At that time, the secret key and the public keys are written to the internal register 31. This process sequence performed at the start of use is referred to as an initial setup process.

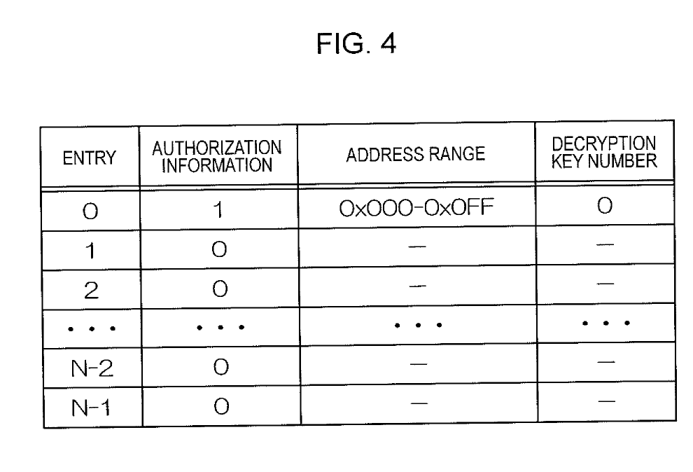

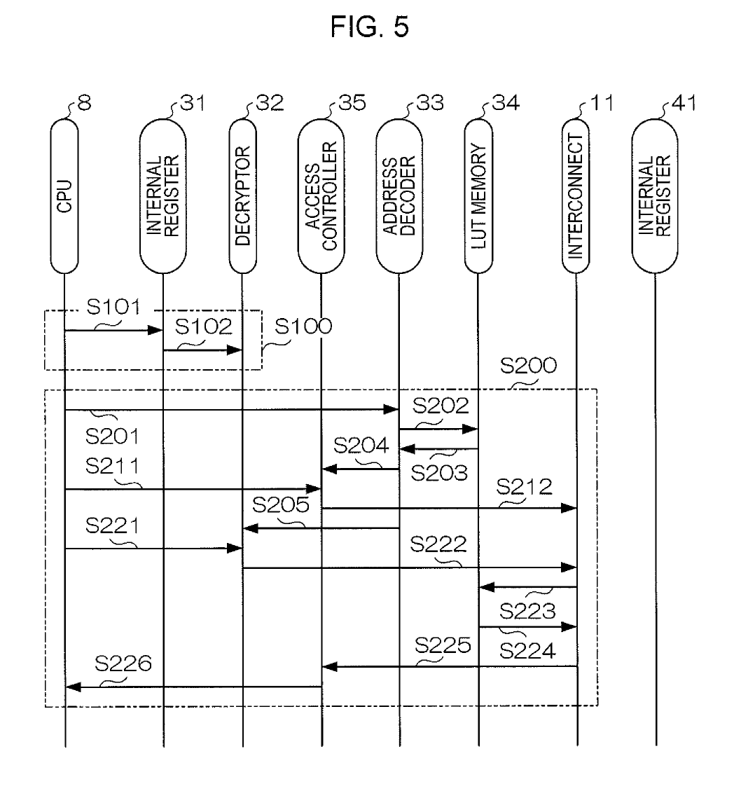

FIG. 4 illustrates an example of the LUT stored before the initial setup process. In the example illustrated in FIG. 4, the authorization information “1”, the address range “0x000-0x0FF”, and the decryption key number “0” are associated with the entry “0”; whereas the authorization information “0” and a symbol “−” indicating that information is not available are associated with the other entries. As described above, the address range “0x000-0x0FF” is the address range of the internal register 31. An operation performed by the individual units of the image processing apparatus 1 during a process for updating the LUT illustrated in FIG. 4 to the LUT illustrated in FIG. 3, that is, during the initial setup process, will be described with reference to FIG. 5.

FIG. 5 illustrates an example of a procedure of an operation performed by the individual units during the initial setup process. This operation procedure starts in response to the user of the image processing apparatus 1 performing an operation to start the initial setup after the provider of the image processing apparatus 1 supplies the user with key data, which represents a secret key, L public keys (public key 0, . . . , public key (L-1)), and decryption key numbers (numbers assigned to the public keys 0 to (L-1)) and update data, which represents the update content of the LUT, and the user stores the key data and the update data on the storage 3.

First, the CPU 8 reads the key data from the storage 3 and stores the secret key, the public keys, and the decryption key numbers represented by the key data on the internal register 31 (step S101). Then, the internal register 31 supplies the stored secret key and the public keys to the decryptor 32 (step S102). Steps S101 and S102 correspond to a key installation process S100 in which the key data is installed.

The CPU 8 then supplies the address decoder 33 with address data that specifies the address where the LUT of the LUT memory 34 is stored (step S201), supplies the access controller 35 with the command data representing a command for instructing update of the LUT (step S211), and supplies the decryptor 32 with, as the encrypted write data, encrypted update data that has been encrypted by using the secret key and the public key 0 (step S221). The steps S201, S211, and 5221 may be performed in series or in parallel.

Upon being supplied with the address data in step S201, the address decoder 33 refers to the LUT (LUT illustrated in FIG. 4) stored on the LUT memory 34 (step S202) and reads the authorization information “1” and the decryption key number “0” associated with the address specified by the address data (step S203). The address decoder 33 then supplies the read authorization information to the access controller 35 together with the address data (step S204) and supplies the read decryption key number to the decryptor 32 (step S205).

Upon being supplied with the authorization information “1” (authorized) and the address data in 204 and with the command data in step S211, the access controller 35 supplies the command data and the address data to the interconnect 11 (step S212).

Upon being supplied with the decryption key number “0” in step S205 and with the encrypted write data in step S221, the decryptor 32 decrypts the encrypted write data by using the public key indicated by the decryption key number and the secret key, and supplies the resultant write data, i.e., the LUT update data, to the interconnect 11 (step S222). The interconnect 11 supplies the LUT memory 34 with the command data and the address data supplied in step S212 and the update data supplied in 222 (step S223).

The LUT memory 34 updates the LUT stored at the address specified by the supplied address data by using the supplied update data in accordance with the instruction of the command represented by the supplied command data, and supplies response data indicating that the LUT has been updated to the interconnect 11 (step S224). The interconnect 11 supplies the response data to the access controller 35 (step S225). The access controller 35 supplies the response data to the CPU 8 (step S226). Steps S201 and 5226 correspond to an update process 5200 in which the LUT is updated.

As described above, the public key assigned the decryption key number “0” illustrated in FIG. 4 is a key used to decrypt the encrypted update data and is an example of a “first decryption key” according to an aspect of the present invention. The decryptor 32 that stores this public key is an example of a “second memory” according to an aspect of the present invention. The decryptor 32 decrypts encrypted update data by using the first decryption key stored therein (the public key assigned “0” in this exemplary embodiment) in response to a request to update the LUT based on the update data representing the update content of the LUT. The access controller 35 updates the LUT by using the update content represented by the update data if the encrypted update data is successfully decrypted in this manner. The access controller 35 is an example of an “updating unit” according to an aspect of the present invention.

The image processing apparatus 1 performs a module use process for using each of the modules 40 by using the LUT that has been updated in the above manner.

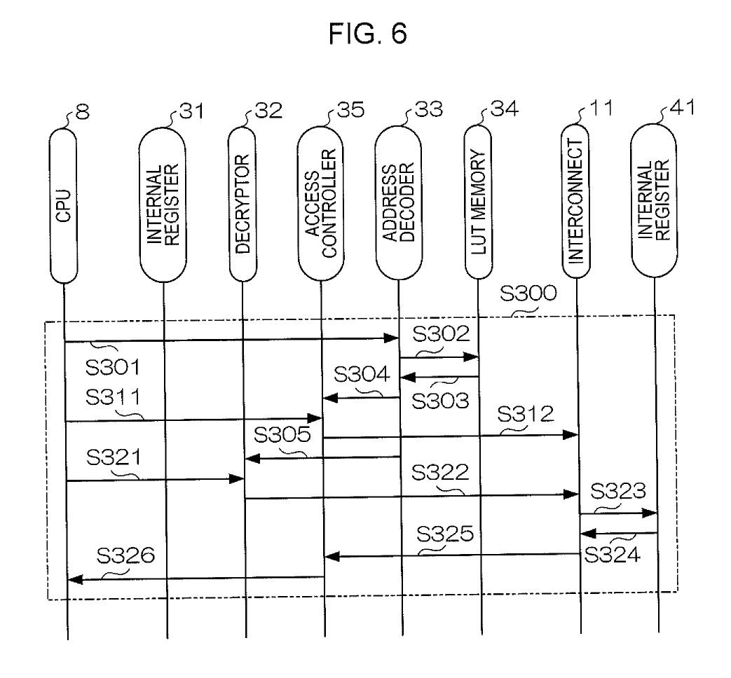

FIG. 6 illustrates an example of a procedure of an operation performed by the individual components during the module use process. This operation procedure starts in response to a request for a process for using the module 40 that is made by a user operation or the like.

First, the CPU 8 supplies the address decoder 33 with address data that specifies an address in the internal register 41 of the module 40 (step S301), supplies the access controller 35 with command data that represents an instruction command to perform requested processing (step S311), and supplies the decryptor 32 with encrypted write data encrypted using the public key associated with the address supplied in step S301 and the secret key (step S321). Steps S5301, S311, and S321 may be performed in series or in parallel.

Upon being supplied with the address data in step S301, the address decoder 33 refers to the LUT (LUT illustrated in FIG. 3) stored on the LUT memory 34 (step S302) and reads the authorization information and the decryption key number associated with the address specified by the address data (step S303). The address decoder 33 supplies the access controller 35 with the read authorization information together with the address data (step S304) and supplies the decryptor 32 with the read decryption key number (step S305).

It is assumed that the authorization information “1” (authorized) is supplied in step S304 in this example. Upon being supplied with the authorization information and the address data in step S304 and with the command data in step S311, the access controller 35 supplies the interconnect 11 with the command data and the address data (step S312).

Upon supplied with the decryption key number in step S305 and with the encrypted write data in step S321, the decryptor 32 decrypts the encrypted write data by using the public key indicated by the decryption key number and the secret key, and supplies the resultant write data to the interconnect 11 (step S322). The interconnect 11 supplies the internal register 41 of the module 40 with the command data and the address data supplied in step S312 and the write data supplied in step S322 (step S323).

The module 40 performs the requested process on the basis of the write data, the address data, and the command data supplied to the internal register 41 and supplies the interconnect 11 with response data indicating that the processing has been performed (step S324). The interconnect 11 supplies the access controller 35 with the response data (step S325). The access controller 35 supplies the CPU 8 with the response data (step S326). Steps S301 to S326 correspond to an execution process S300 in which the module 40 performs the requested processing.

As described above, the public keys each assigned the corresponding decryption key number (one of the decryption key numbers associated with the entries “1” to “N-1”) associated with the corresponding address range of the divisional space illustrated in FIG. 3 is a key associated with an address of the divisional space and is an example of a “second decryption key” according to an aspect of the present invention. The decryptor 32 that stores these public keys is an example of a “third memory” according to an aspect of the present invention.

The decryptor 32 decrypts the encrypted write data by using the second decryption key (for example, the public key assigned “6”) stored therein, in response to a request to write the write data to the specified address. If the encrypted write data is decrypted by using the public key associated with the specified address and the secret key, the access controller 35 writes the resultant write data to the specified address.

In this exemplary embodiment, writing of data is authorized for each divisional space of the internal register 41 of the module 40. With this configuration, if the module has multiple functions and divisional spaces used for the respective functions are determined, whether use is authorized or not is managed on a function-by-function basis. In addition, if there is a function that uses one of plural parameters and divisional spaces used for the respective parameters are determined, whether use is authorized or not is managed on a parameter-by-parameter basis. As described above, according to this exemplary embodiment, whether use is authorized or not is managed for each element, such as each function or each parameter of the module 40.

In addition, in this exemplary embodiment, encrypted update data is decrypted by using a public key assigned the decryption key number (“0” in the example illustrated in FIG. 4) associated with the address range of the internal register 31. Accordingly, the LUT is not updated unless the update data is data encrypted by using a key corresponding to the public key.

In addition, in this exemplary embodiment, encrypted write data is decrypted using a public key assigned the decryption key number associated with the address range of a corresponding divisional space (one of the decryption key numbers associated with the entries “1” to “N-1” in the example illustrated in FIG. 3). Accordingly, the write data is not written to the specified address unless the write data is data encrypted by using a key corresponding to such a public key.

Further, in this exemplary embodiment, the access controller 35 sends a notification to the CPU 8 if the specified address is not included in an address range authorized to be used. The CPU 8 sometimes issues the next data write request on the basis of the result of writing the write data. In such a case, the CPU 8 issues the next data write request, for example, after a predetermined period of time has passed if this notification is not made. However, since the access controller 35 makes this notification in this exemplary embodiment, the CPU 8, which is a source of a data write request, issues the next data write request earlier than in the case where this notification is not made.

### 2. Modifications

The exemplary embodiment described above is merely an example of how the present invention is embodied and may be modified in the following manner. In addition, the exemplary embodiment and each of the modifications may be carried out in combination as needed.

### 2-1. Information Processing Apparatus

The exemplary embodiment of the present invention is applicable to information processing apparatuses other than the image processing apparatus 1. For example, the exemplary embodiment of the present invention may be applied to a server apparatus, and usable functions and parameters may be managed on a user-by-user basis. In addition, the exemplary embodiment of the present invention may be applied to a kiosk terminal that is installed at a store or the like and provides various functions, and usable functions and parameters may be managed on a store-by-store basis. In short, the exemplary embodiment of the present invention is applicable to any kinds of information processing apparatuses that manage functions and parameters of modules on a user-by-user basis.

### 2-2. Configuration of Information Processing Apparatus

The configuration of the information processing apparatus to which the exemplary embodiment of the present invention is applied is not limited to the configuration illustrated in FIGS. 1 and 2, and the information processing apparatus may have various configurations. In either case, the information processing apparatus is required to include at least components equivalent to the “processing circuit”, the “first memory”, and the “writing unit” according to the aspect of the present invention and may include components equivalent to the “second memory”, the “updating unit”, the “third memory”, the “notification unit”, and the “requesting unit” according to the aspect of the present invention if necessary.

### 2-3. Reading of Data

In the exemplary embodiment, the case of requesting writing of write data to a specified address in a memory space (the internal register 41) of the module 40 has been described. There may be a case where a request is issued to read data from a specified address. In this case, the access controller 35 reads the data from the specified address if the LUT memory 34 stores permission information (LUT) indicating a range including the address. The access controller 35 is an example of a “reading unit” according to an aspect of the present invention. In this modification, whether use is authorized or not is also managed for each element, such as each function and each parameter of the module 40.

### 2-4. Categories of Invention

The present invention is construed as an integrated circuit including the license management unit 30 and the modules 40, just like the SOC 20, and as an information processing apparatus including such an integrated circuit, just like the image processing apparatus 1, the server apparatus, and the kiosk terminal described above. In addition, the present invention is construed as an information processing method for implementing a process performed by the integrated circuit or the image processing apparatus and as a program causing a computer to perform the process. This program may be provided in a form of a recording medium, such as an optical disc storing the program thereon, or may be downloaded and installed on a computer via a communication line, such as the Internet, so as to be usable.

The foregoing description of the exemplary embodiment of the present invention has been supplied for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An integrated circuit comprising:
a processing circuit that includes a memory space and that stores data in the memory space and performs processing;
a first memory that stores permission information indicating a range permitted to be used in the memory space; and
a writing unit that writes, in response to a request to write data to a specified address in the memory space, the data to the specified address in a case where the permission information indicating a range including the specified address is stored.

2. The integrated circuit according to claim 1, further comprising:
a second memory that stores a first decryption key used to decrypt encrypted data; and
an updating unit that updates, in response to a request to update the permission information in accordance with update data representing update content of the permission information and in a case where the update data is successfully decrypted by using the first decryption key stored in the second memory, the permission information by using the update content represented by the resultant update data.

3. The integrated circuit according to claim 1, further comprising:
a third memory that stores a second decryption key associated with the specified address in the memory space,
wherein the writing unit writes, in response to a request to write data to the specified address and in a case where the data is successfully decrypted using the second decryption key associated with the specified address, writes the resultant data to the specified address.

4. The integrated circuit according to claim 1, further comprising:
a notification unit that sends, if the specified address is not included in the range, a notification to a source of the request to write the data to the specified address.

5. An information processing apparatus comprising:
the integrated circuit according to claim 1; and
a requesting unit that issues the request to write the data by specifying the address in the memory space.

6. An integrated circuit comprising:
a processing circuit that includes a memory space and that stores data in the memory space and performs processing;
a first memory that stores permission information representing a range permitted to be used in the memory space; and
a reading unit that reads, in response to a request to read data from a specified address in the memory space, the data from the specified address in a case where the permission information representing a range including the specified address is stored.

7. An information processing method comprising:
storing data in a memory space and performing processing;
storing, on a first memory, permission information indicating a range permitted to be used in the memory space; and
writing, in response to a request to write data to a specified address in the memory space, the data to the specified address in a case where the permission information indicating a range including the specified address is stored.
